(19) United States
(12) Patent Application Publication
(10) Pub. No.: US 2025/0322116 A1
(43) Pub. Date: Oct. 16, 2025

(54) SIMULATOR, SIMULATION METHOD, AND COMPUTER READABLE STORAGE MEDIUM

(71) Applicants: MITSUBISHI HEAVY INDUSTRIES, LTD., Tokyo (JP); FLORIDA STATE UNIVERSITY RESEARCH FOUNDATION, INC., Tallahassee, FL (US)

(72) Inventors: Shunya ISHIGURO, Tokyo (JP); Kazuki WATANABE, Tokyo (JP); Yuki IZUMIDA, Tokyo (JP); Satoshi SUEHIRO, Tokyo (JP); James Lee LANGSTON, Tallahassee, FL (US); Harsha RAVINDRA, Tallahassee, FL (US)

(21) Appl. No.: 18/631,504

(22) Filed: Apr. 10, 2024

(51) Int. Cl. G06F 30/18

(52) U.S. Cl. CPC G06F 30/18

(57) ABSTRACT

To facilitate improvement in accuracy of a simulation and improvement in stability of a system, a simulator calculates a compensation signal, which is for compensating output of a power supply element of a simulation model 33, by using an electrical signal of the DUT 5, an electrical signal of a power system model 41, and a virtual electrical characteristic element virtually representing a part or all of an electrical characteristic related to the resistance of a DUT 5, calculates a feedback electrical signal by using the compensation signal and the electrical signal of the DUT 5, and outputs the feedback electrical signal to the power supply element of the simulation model 33.

### BACKGROUND

### 1. Technical Field

The present disclosure relates to a simulator, a simulation method, and a computer readable storage medium.

### 2. Description of Related Art

Simulation systems using Power Hardware in the Loop (PHIL) are conventionally known as a test system for an electric power system or a control system that is grid-connected to an electric power system (for example, a power converter or the like) (for example, U.S. Patent Publication No. 2018/0172778).

For example, as illustrated in FIG. 20, in a configuration of such a simulation system using a PHIL simulation, a real time simulator (RTS) and a device under test (DUT) are connected via an interface, and the RTS has an electric power system and the like implemented as a simulation model.

In test systems using a PHIL simulation, there is a concern that a signal transmission delay or the like may occur due to intervening of an interface resulting in reduced simulation accuracy and instability.

Various interface algorithms have conventionally been developed as schemes for improving accuracy in PHIL simulations. As illustrated in FIG. 20, Damping Impedance Method (DIM), which is one of these interface algorithms, is a scheme to improve stability and accuracy of the system by connecting a damping impedance element emulated with a network of linear circuit elements (hereafter, referred to as “explicit impedance element”) Z* in series to a voltage source of a simulation model and identifying this explicit impedance element Z* as a DUT impedance characteristic Z_{B}.

Assuming here that the internal impedance of an amplifier is negligible, a transfer function G_{OL} of the DIM open loop system can be expressed as Equation (1) below.

$$\begin{matrix}[ Equation . l ] & \\ {G}_{OL} = \frac{{Z}_{A} {T}_{amp} ( {Z}_{B} - {Z}^{*} )}{{Z}_{B} ( {Z}_{A} + {Z}^{*} )} & ( 1 )\end{matrix}$$

In Equation (1), Tamp denotes the characteristic of an amplifier of an interface, and ZA denotes the impedance characteristic of a power system model implemented by a real time simulator. Since the explicit impedance element Z* and the DUT impedance characteristic Z_{B} are matched and thereby the transfer function G_{OL} converges to zero (0), the effect of the interface can be minimized as much as possible.

U.S. Patent Publication No. 2018/0172778 is an example of the related art.

### BRIEF SUMMARY

When the DUT impedance characteristic is representative of a network of passive linear components, the explicit impedance is relatively easily identified, which can achieve effective improvement in accuracy or stability of a simulation. However, when the impedance characteristic is complex or when a nonlinear characteristic is included as with a power converter or the like, for example, it is difficult to match the explicit impedance to the DUT impedance characteristic. In such a case, in the numerator of Equation (1) above, it is not possible to have Z_{B}=Z*, and errors will be superimposed. As a result, the stability of the system may compromise, and the simulation accuracy may be significantly reduced.

The present disclosure has been made in view of such circumstances and intends to provide a simulator, a simulation method, and a computer readable storage medium that can easily achieve improvement in accuracy of a simulation and improvement in stability of a system.

A simulator according to one aspect of the present disclosure is a simulator including at least one simulation model including a power system model of a modelled electric power system to which a device under test is connected, the simulator being configured to connect to a device under test as hardware via an interface and perform a simulation on the simulation model to test an operation of the device under test. The simulator includes: one or more memories storing the simulation model and a program; and one or more processors configured to execute the program to: calculate a compensation signal by using a virtual electrical characteristic element, an electrical signal of the device under test, and an electrical signal of the power system model, the compensation signal being for compensating output of a power supply element of the simulation model, and the virtual electrical characteristic element virtually representing a part or all of an electrical characteristic related to the resistance of the device under test; calculate a feedback electrical signal by using the compensation signal and the electrical signal of the device under test; and output the feedback electrical signal to the power supply element of the simulation model.

A simulation method according to one aspect of the present disclosure is a simulation method for testing an operation of a device under test as hardware by connecting a simulator to the device under test via an interface and performing a simulation on at least one simulation model, the simulator including the simulation model, and the simulation model including a power system model of a modelled electric power system to which the device under test is connected. The simulation method includes: at the simulator, calculating a compensation signal by using a virtual electrical characteristic element, an electrical signal of the device under test, and an electrical signal of the power system model, the compensation signal being for compensating output of a power supply element of the simulation model, and the virtual electrical characteristic element virtually representing a part or all of an electrical characteristic related to the resistance of the device under test; calculating a feedback electrical signal by using the compensation signal and the electrical signal of the device under test; and outputting the feedback electrical signal to the power supply element of the simulation model.

One aspect of the present disclosure is a non-transitory computer readable storage medium storing a program that causes a computer to function as the simulator described above.

### BRIEF DESCRIPTION OF THE SEVERAL VIEWS OF THE DRAWINGS

FIG. 1 is a diagram illustrating an overall configuration of a simulation system according to a first embodiment of the present disclosure.

FIG. 2 is a diagram illustrating an example of a hardware configuration of a simulator according to the first embodiment of the present disclosure.

FIG. 3 is a diagram illustrating a simulation model as an example implemented by the simulator according to the first embodiment of the present disclosure in a block diagram.

FIG. 4 is a diagram illustrating an example of a feedback voltage calculation model according to the first embodiment of the present disclosure in a block diagram.

FIG. 5 is a diagram illustrating a simulation model as an example implemented by a simulator according to a second embodiment of the present disclosure in a block diagram.

FIG. 6 is a diagram illustrating an example of an impedance characteristic of a device under test.

FIG. 7 is a diagram illustrating a low frequency characteristic of the impedance characteristic illustrated in FIG. 6.

FIG. 8 is a diagram illustrating a high frequency characteristic of the impedance characteristic illustrated in FIG. 6.

FIG. 9 is a diagram illustrating an example of a simulation model of a simulator according to a third embodiment of the present disclosure in a block diagram.

FIG. 10 is a diagram illustrating an example of a correction calculation model according to the third embodiment of the present disclosure in a block diagram.

FIG. 11 is a diagram illustrating simulation models as an example implemented by a simulator according to a fourth embodiment of the present disclosure in a block diagram.

FIG. 12 is a diagram illustrating a feedback voltage calculation model as an example according to the fourth embodiment of the present disclosure in a block diagram.

FIG. 13 is a diagram illustrating a model of a compensation voltage calculation element as an example according to the fourth embodiment of the present disclosure in a block diagram.

FIG. 14 is a diagram illustrating an example of impedance components Z_{dd}, Z_{qq} of a device under test according to the fourth embodiment of the present disclosure.

FIG. 15 is a diagram illustrating an example of impedance components Z_{dq}, Z_{qd} of the device under test according to the fourth embodiment of the present disclosure.

FIG. 16 is a diagram illustrating a configuration example of a feedback voltage calculation model when a non-functional virtual interface characteristic is used.

FIG. 17 is a diagram illustrating a block diagram of an example of a virtual interface according to a modified example of the present disclosure.

FIG. 18 is a diagram illustrating an example of a feedback current calculation model according to a modified example of the present disclosure in a block diagram.

FIG. 19 is a diagram illustrating an example of a compensation current calculation element according to a modified example of the present disclosure.

FIG. 20 is a diagram illustrating a general configuration of a simulation system using a PHIL simulation.

### DETAILED DESCRIPTION

### First Embodiment

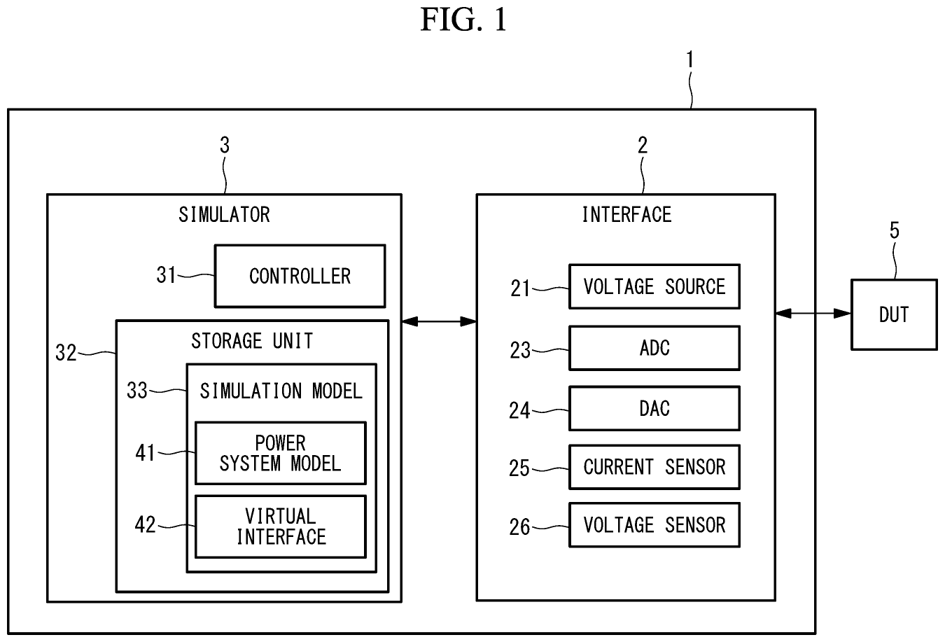

A simulator, a simulation method, and a computer readable storage medium according to a first embodiment of the present disclosure will be described below with reference to FIG. 1.

FIG. 1 is a diagram illustrating an overall configuration of a simulation system 1 according to the present embodiment. The simulation system 1 according to the present embodiment tests and evaluates the operation of a device under test (hereafter, referred to as “DUT”) 5 by using a PHIL simulation, for example.

The DUT 5 is a hardware component to be tested and may be a power converter, a controller, or the like as an example. Specifically, the DUT 5 may be a power conditioning system (PCS), an uninterruptible power supply (UPS), an inverter, or the like. Although an actual hardware component (real machine) is used as the DUT 5 in the present embodiment, the DUT 5 is not limited thereto. For example, a miniature model scaled down from a real machine in terms of the capacity or the like while having the same function as the real machine can also be used.

The simulation system 1 includes an interface 2 and a simulator 3.

For example, the interface 2 is interposed between the simulator 3 and the DUT 5 and realizes transfer of signals and power (voltage and current) between the DUT 5 and the simulator 3.

For example, the interface 2 includes a voltage source 21, an analog-to-digital converter (hereafter, referred to as “ADC”) 23, a digital-to-analog converter (hereafter, referred to as “DAC”) 24, a current sensor 25, a voltage sensor 26, and the like. The current sensor 25 determines the current flowing in the DUT 5 and outputs a current signal I₂ based on the determined current value. The voltage sensor 26 determines the voltage of the DUT 5 and outputs a voltage signal V₂ based on the determined voltage value. Note that sensors provided in the DUT 5 may be used as the current sensor 25 and the voltage sensor 26, and in such a case, the current sensor 25 and the voltage sensor 26 can be omitted in the interface 2.

An analog current signal detected by the current sensor 25 and an analog voltage signal detected by the voltage sensor 26 are converted into digital signals by the ADC 23, and these digital signals are output to the simulator 3.

Further, the interface 2 converts a digital voltage signal output from the simulator 3 into an analog signal by the DAC 24 and outputs the analog signal to the voltage source 21. The voltage source 21 amplifies a voltage signal output from the simulator 3 and supplies the amplified voltage signal to the DUT 5. Accordingly, a voltage corresponding to a voltage signal output from the simulator 3 is supplied to the DUT 5.

Note that a known technology used for PHIL simulations may be used as appropriate for the interface 2, and the detailed description thereof will be omitted.

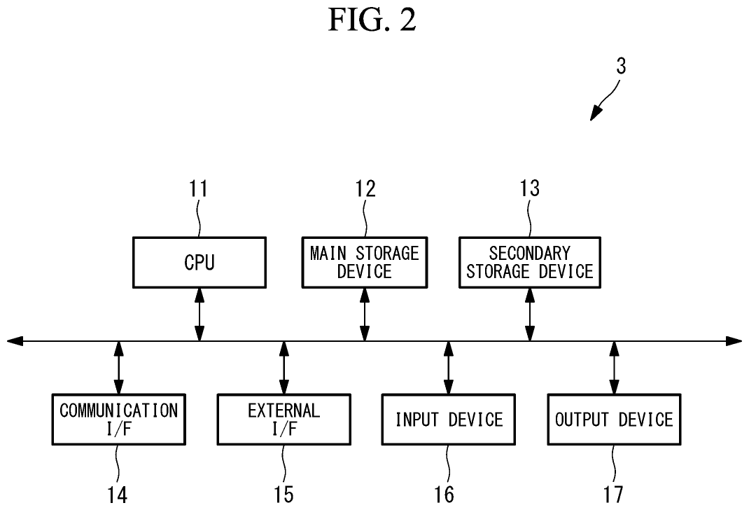

The simulator 3 is a real time simulator (RTS), for example. FIG. 2 is a diagram illustrating an example of a hardware configuration of the simulator 3. As illustrated in FIG. 2, the simulator 3 is formed of a computer or the like and includes, for example, a central processing unit (CPU; processor) 11, a main storage device (main memory) 12, a secondary storage device (secondary storage; memory) 13, and the like. These components are connected to each other directly or indirectly via a bus and perform various processes in cooperation with each other.

The simulator 3 may include a communication interface 14, an external interface 15, an input device 16, an output device 17, and the like. The input device 16 and the output device 17 may be connected to the CPU 11 and the like via a bus or may be connected thereto via the communication interface 14 or the external interface 15.

For example, the CPU 11 controls the entire simulator 3 by the operating system (OS) stored in the secondary storage device 13 connected via a bus and executes various programs stored in the secondary storage device 13 to perform various processes. A single CPU 11 may be provided, or multiple CPUs 11 may be provided to implement processes in cooperation with each other.

Examples of the CPU 11 may be a microprocessor, a microcontroller, a vector processor, a graphics processing unit (GPU), a digital signal processor (DSP), an application-specific integrated circuit (ASIC), or the like. The simulator 3 may include one or more processors or may include a combination of a plurality of processors.

For example, the main storage device 12 is formed of a writable memory such as a cache memory, a random access memory (RAM), or the like and is used as a work area for loading an execution program of the CPU 11 therein and writing processed data thereto or the like by the execution program.

The secondary storage device 13 is a non-transitory computer readable storage medium. For example, the secondary storage device 13 is a magnetic disk, a magnetic optical disk, a CD-ROM, DVD-ROM, a semiconductor memory, or the like. Examples of the secondary storage device 13 may be a read only memory (ROM), a hard disk drive (HDD), a solid state drive (SSD), a flash memory, or the like. For example, the secondary storage device 13 stores the OS used for controlling the entire simulator 3 such as Windows (registered trademark), iOS (registered trademark), Android (registered trademark), or the like, basic input/output system (BIOS), various device driver for hardware operation of peripheral devices, various application software, and various data or files or the like. Further, the secondary storage device 13 stores programs used for implementing various processes for implementing a simulation described later or various data required for implementing various processes. The program may include various application software such as MATLAB, Simulink (registered trademark), Simulink Coder, or the like.

A plurality of secondary storage devices 13 may be provided, and the program or data described above may be divided and stored in respective secondary storage devices 13.

The communication interface 14 functions as an interface for connecting to a network to communicate with other devices and transmitting and receiving information. For example, the communication interface 14 communicates with other devices via a wired connection or a wireless connection. The wireless communication may be communication over a line such as Bluetooth (registered trademark), Wi-Fi, a mobile communication system (3G, 4G, 5G, 6G, LTE, or the like), a wireless local area network (LAN), or the like. An example of wired communication may be communication over a line such as a wired LAN.

The external interface 15 is an interface for connecting to an external device. An example of the external device may be an external monitor, a USB memory, an external HDD, an external camera, or the like. Note that, although only one external interface 15 is depicted in the example illustrated in FIG. 1, a plurality of external interface 15 may be provided.

An example of the input device 16 may be a keyboard, a touch pad, a pointing device, or the like. An example of the pointing device may be a mouse, a touch panel, a pen tablet, a trackpad, a trackball, or the like.

An example of the output device 17 may be a display, a projector, a printer, or the like.

A series of processes for implementing functions described later are stored in the secondary storage device 13 or the like in a form of a program as an example, and various functions are implemented when the CPU (processor) 11 loads the program into the main storage device 12 and performs modification and calculation processes on information. Note that, for the program, a form of being installed in advance in the secondary storage device 13, a form of being provided in a state of being stored in a non-transitory computer readable storage medium, a form of being delivered via a wired or wireless communication connection, or the like may be applied. An example of the non-transitory computer readable storage medium may be a magnetic disk, a magnetic optical disk, a CD-ROM, a DVD-ROM, a semiconductor memory, or the like.

As illustrated in FIG. 1, the simulator 3 has functions of a controller 31 that performs a simulation, a simulation model 33, a storage unit 32 that stores various programs or the like, and the like. The simulation model 33 includes, for example, a power system model 41 and a virtual interface 42, and the power system model 41 models a power system such as an electric power system or a plant to which the DUT 5 is connected. For example, a power generator, a transformer, or the like may be incorporated as a model in the power system model 41.

The simulation model 33 serves as a model that can cause an abnormal state such as a failure, an accident, or the like in order to test a response of the DUT 5 or inspect the operation thereof, for example. For example, when an electric power system is to be connected, the simulation model 33 may be configured to be able to emulate behavior or the like occurring at an accident in accordance with the coordination regulation (for example, IEEE 1547 or the like).

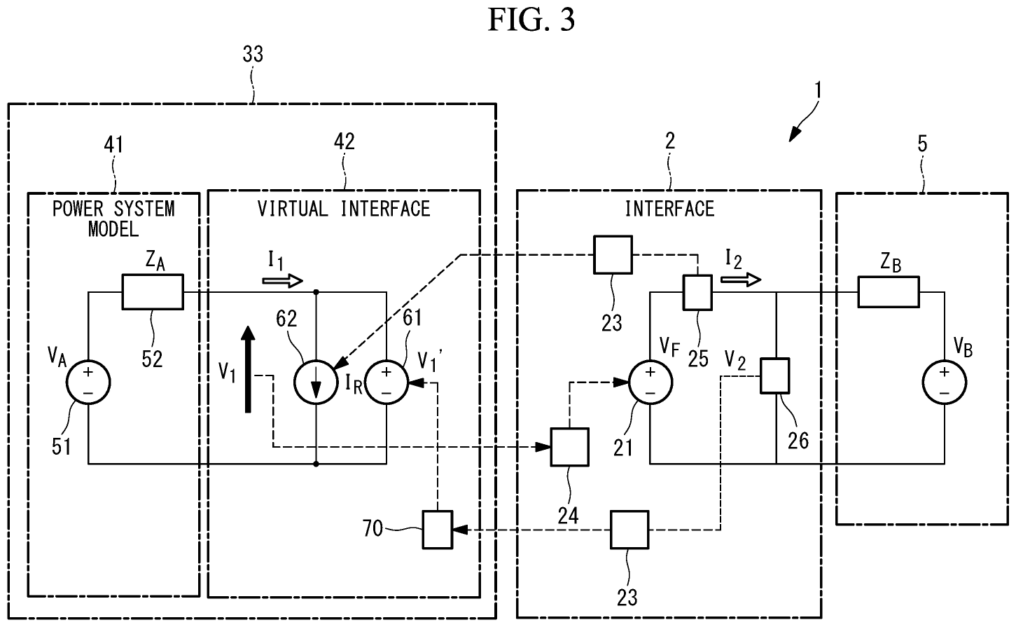

FIG. 3 is a diagram illustrating the simulation model 33 as an example implemented by the simulator 3 according to the present embodiment in a block diagram. As illustrated in FIG. 3, the simulation model 33 includes the power system model 41 and the virtual interface 42, for example.

The power system model 41 has a power supply element 51 and an impedance element 52, for example. In the present embodiment, the power supply element 51 is a modeled single-phase AC power supply. The impedance element 52 is a modeled internal impedance inherent in the power system.

The virtual interface 42 includes a power supply element for transferring the operation state of the DUT 5 to the power system model 41, a feedback voltage calculation model (feedback voltage calculation unit) 70, and the like. The power supply element includes a voltage source element 61 and a current source element 62.

The voltage source element 61 and the current source element 62 are connected parallel to the output side of the power system model 41. The current source element 62 virtually generates current in accordance with a current signal supplied from the ADC 23 of the interface 2.

The feedback voltage calculation model 70 transfers a voltage signal of the DUT 5 to the simulation model 33.

For example, the feedback voltage calculation model (feedback model) 70 calculates a compensation signal, which is used for compensating the output of the power supply element of the simulation model 33, by using a virtual electrical characteristic element virtually representing a part or all of an electrical characteristic related to the resistance of the DUT 5 and using an electrical signal of the DUT 5 and an electrical signal of the power system model 41, calculates a feedback electrical signal by using the compensation signal and the electrical signal of the DUT 5, and outputs the feedback electrical signal to a power supply element of the simulation model.

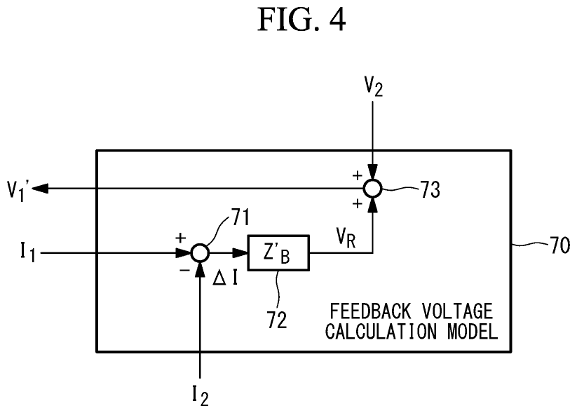

FIG. 4 is a diagram illustrating an example of the feedback voltage calculation model 70 in a block diagram. Herein, the feedback voltage calculation model 70 is a model to calculate a compensation voltage signal used for compensating the output of the voltage source element 61. Note that, while described later, the model may be configured to compensate the output of the current source element 62, instead of the voltage source element 61.

As illustrated in FIG. 4, the feedback voltage calculation model 70 includes a subtraction element (subtraction unit) 71, a compensation voltage calculation element (compensation voltage calculation unit) 72, and an addition element (addition unit) 73.

For example, the subtraction element 71 acquires a current signal I₁ of the power system model 41 and a current signal I₂ of the DUT 5 and outputs a differential current signal ΔI (=I₁−I₂) that is the difference between these current signals.

The compensation voltage calculation element 72 includes a virtual impedance element where an impedance characteristic (electrical characteristic related to the resistance) Z_{B} of the DUT 5 is set as a transfer function. The compensation voltage calculation element 72 calculates (arithmetically calculates) a voltage compensation signal V_{R} by using the virtual impedance element and the differential current signal ΔI. Specifically, the compensation voltage calculation element 72 calculates the voltage compensation signal V_{R} by multiplying the virtual impedance element by the differential current signal ΔI. For instance, the differential current signal ΔI becomes multiplication in the frequency domain.

The addition element 73 calculates a feedback voltage signal V₁ by adding the voltage compensation signal V_{R} to the voltage signal V₂ of the DUT 5. The feedback voltage signal V₁, which is the output of the addition element 73, is input to the voltage source element 61. Accordingly, a virtual voltage in accordance with the feedback voltage signal V₁ is generated by the voltage source element 61.

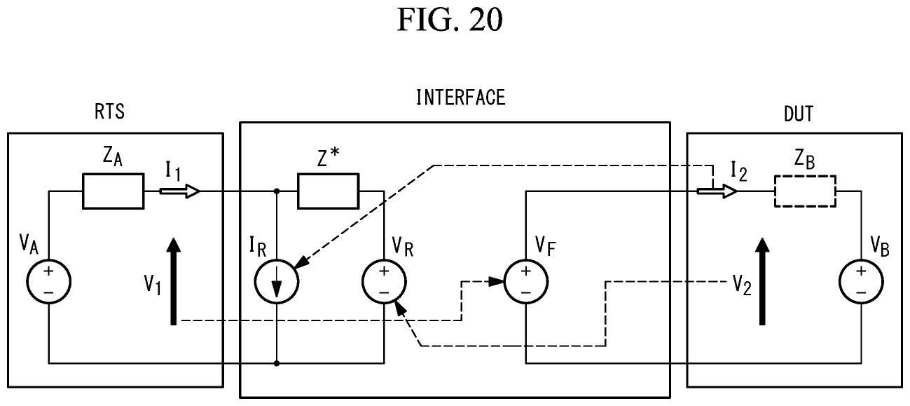

As discussed above, in the simulator 3 of the present embodiment, the virtual impedance element representing the impedance characteristic Z_{B} of the DUT 5 as a function is used instead of the conventionally employed explicit impedance (see FIG. 20). This virtual impedance element is then used to calculate a voltage drop ΔV (=(I₁−I_{R})×Z*), which would be obtained by using the conventional explicit impedance, as the voltage compensation signal V_{R}, and this voltage compensation signal V_{R} is reflected to the voltage signal V₂ fed back from the DUT 5 to the simulation model 33. This makes it possible to adjust the voltage of the simulation model 33 as if the explicit impedance were provided. Note that, for instance, the differential current signal ΔI (=I₁−I_{R}) becomes multiplication in the frequency domain.

Next, an example of a method of setting a virtual impedance element in a process of generating the simulation model 33 implemented by the simulator 3 according to the present embodiment will be described.

First, the impedance characteristic of the DUT 5 is acquired. In this step, for example, a predetermined reference voltage signal is supplied to the DUT 5 via the interface 2. For example, a reference single-phase AC voltage signal V(t) at a rated voltage and a rated frequency is output to the DAC 24 of the interface 2. This reference single-phase AC voltage signal V(t) is supplied to the voltage source 21 via the DAC 24. Accordingly, the DUT 5 is driven, and the current signal I₂(t) and the voltage signal V₂(t) at this time are measured by the current sensor 25 and the voltage sensor 26, respectively.

Subsequently, the impedance characteristic Z_{B} of the DUT 5 is arithmetically calculated based on the current signal I₂(t) and the voltage signal V₂(t). The impedance characteristic Z_{B} is then expressed as a transfer function and set for the virtual impedance element of the compensation voltage calculation element 72 of the feedback voltage calculation model 70.

Once the virtual impedance element of the feedback voltage calculation model 70 is set in such a way, the DUT 5 is ready to be tested, and a simulation test on the DUT 5 may be started at any timing.

Note that, for a scheme to acquire the impedance characteristic of the DUT 5, a known technology can be employed as appropriate without being limited to the example described above. That is, since various methods have been proposed as schemes to acquire the impedance characteristic of a hardware component in operation, these known schemes may be employed as appropriate.

Next, the simulation method performed by the simulation system 1 will be described.

Out of a series of processes described below, some or all of the processes performed by the simulator are stored in the secondary storage device 13 (see FIG. 2) or the like in a form of a program as an example and implemented when the CPU (processor) 11 loads the program into the main storage device 12 and performs modification and calculation processes on information.

During execution of a simulation, various instances are emulated with the power system model 41, and the virtual voltage at the time of the emulation is sensed and output to the voltage source 21 via the DAC 24. The voltage source 21 supplies a voltage in accordance with the input voltage signal V₁ to the DUT 5. Accordingly, the voltage signal V₁ in the power system model 41 is reflected to the DUT 5, and the DUT 5 is operated. The current and the voltage of the DUT 5 are measured by the current sensor 25 and the voltage sensor 26, respectively, the current signal I₂ and the voltage signal V₂ are converted into digital signals by the ADC 23, and these digital signals are fed back to the virtual interface 42.

Specifically, the current signal I₂ of the DUT 5 is input to the current source element 62 of the virtual interface 42 and input to the feedback voltage calculation model 70. Further, the voltage signal V₂ of the DUT 5 is input to the feedback voltage calculation model 70. Further, the current signal I₁ of the power system model 41 is input to the feedback voltage calculation model 70.

In the feedback voltage calculation model 70, a differential current signal ΔI, which is the difference between the current signal I₁ of the power system model 41 and the current signal I₂ sensed at the DUT 5, is arithmetically calculated by the subtraction element 71 and output to the compensation voltage calculation element 72. In the compensation voltage calculation element 72, the differential current signal ΔI and the virtual impedance element Z′B are multiplied, and thereby the voltage compensation signal V_{R} is calculated and output to the addition element 73. In the addition element 73, the voltage compensation signal V_{R} and the voltage signal V₂ of the DUT 5 are summed, and the sum is output to the voltage source element 61 of the virtual interface 42 as the feedback voltage signal V₁.

The processes described above are then repeated, and thereby the PHIL simulation is performed.

As described above, according to the present embodiment, the virtual impedance element representing the impedance characteristic of the DUT 5 as a function and also the current signal I₂ of the DUT 5 and the current signal I₁ of the power system model 41 are used to calculate the voltage compensation signal V_{R}, the voltage compensation signal V_{R} and the voltage signal V₂ of the DUT 5 are used to calculate the feedback voltage signal V₁, and the feedback voltage signal V₁ is output to the voltage source element 61 of the simulation model 33.

As discussed above, with the use of the virtual impedance element representing the impedance characteristic of the DUT 5 as a function, the impedance characteristic Z_{B} of the DUT 5 is expected to be emulated at high accuracy compared to a case of the use of the explicit impedance emulated with a network of linear circuit elements as with the conventional art. In particular, this is effective when the impedance characteristic Z_{B} of the DUT 5 is nonlinear or when it is difficult to emulate the characteristic with the use of a network of linear circuit elements. Accordingly, simulation errors due to intervening of the interface 2 can be effectively reduced, and the simulation accuracy can be improved. Further, the stability of the power system model 41 is expected to improve.

Further, the use of the virtual impedance element can eliminate the need for identifying circuit elements (resistors, inductors, capacitors, or the like) that would be required in using the explicit impedance, and this can make it easier to build a simulation model.

### Second Embodiment

Next, a simulator, a simulation method, and a computer readable storage medium according to a second embodiment of the present disclosure will be described.

In the simulator 3 according to the first embodiment described above, the explicit impedance element Z* emulated with a network of linear circuit elements is not connected in series to the input side of the voltage source element as with the conventional simulation model illustrated in FIG. 20 as an example. Thus, for example, when there is a sudden change in the current of the simulation model 33 due to a topology change of the power system model 41 or the like, the output current may significantly vary. Furthermore, feedback of the current flowing in the simulation model 33 may cause a change of a closed-loop system, and the stability of the closed-loop system may compromise.

Accordingly, in the present embodiment, both the virtual impedance element described above and the explicit impedance are used in combination. Specifically, a part of the impedance characteristic of a DUT is implemented as a virtual impedance element, and the remaining characteristic is emulated as an explicit impedance.

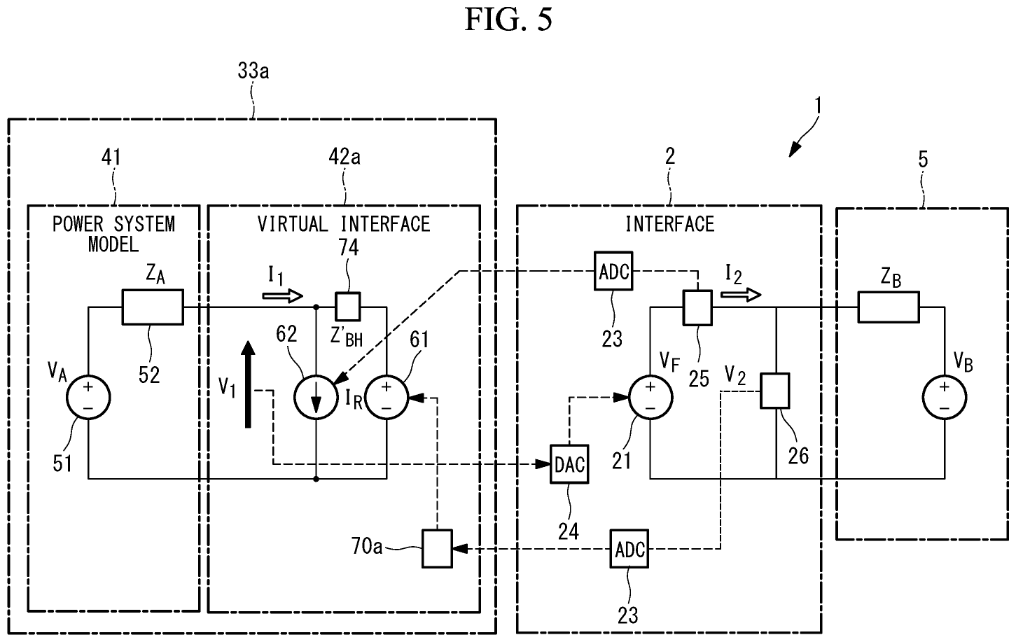

The simulator according to the present embodiment will be described below with reference to FIG. 5. Further, in the followings, description of configurations common to those of the simulator 3 according to the first embodiment will be omitted, and different features will be mainly described.

FIG. 5 is a diagram illustrating a simulation model 33a as an example implemented by the simulator according to the present embodiment in a block diagram. As illustrated in FIG. 5, the simulator according to the present embodiment includes an explicit impedance element 74 connected in series to the input side of the voltage source element 61 in a virtual interface 42a.

Further, while the feedback voltage calculation model 70a has substantially the same configuration as that of the first embodiment described above, the function of a virtual impedance element set for the compensation voltage calculation element 72 differs from that of the first embodiment. Specifically, while the impedance characteristic Z_{B} of the DUT 5 is used as a function and set for a virtual impedance element in the first embodiment described above, an impedance characteristic Z_{B1} that is a part of the impedance characteristic Z_{B} is used as a function and set for the virtual impedance element in the present embodiment. The remaining impedance characteristic Z_{B2} (=Z_{B}−Z_{B1}) is then emulated with a network of linear circuit elements of the explicit impedance element 74. Herein, it is sufficient for the explicit impedance element 74 to include at least any one of a resistor element (R), an inductor element (L), and a capacitor element (C), and it is not necessarily required for the explicit impedance element 74 to be emulated as a circuit including all these elements.

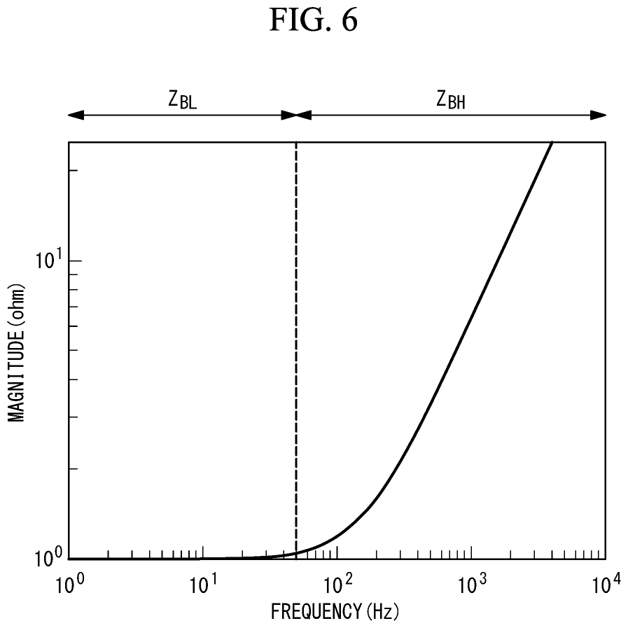

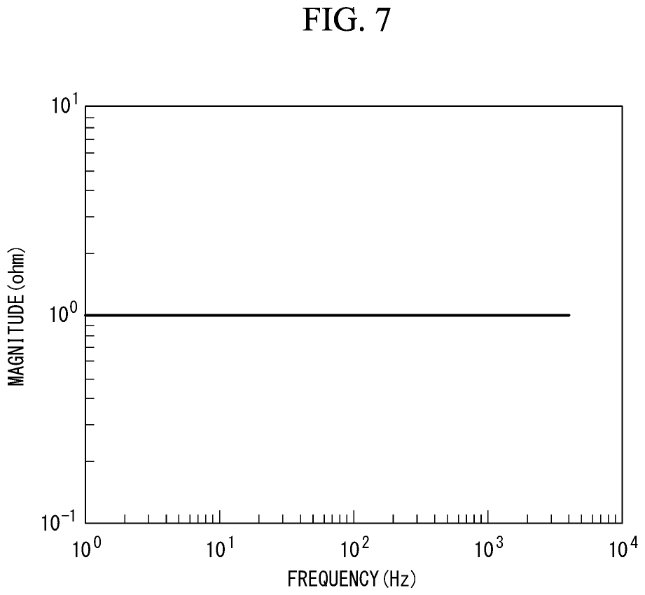

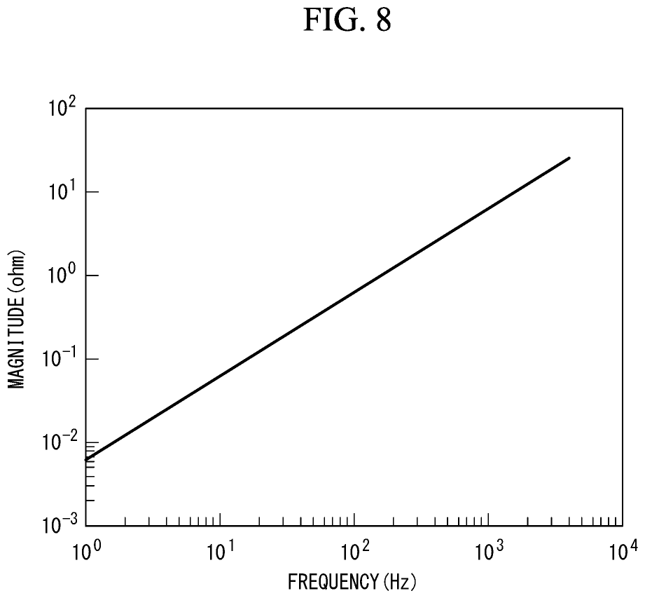

Herein, there are several conceivable ways to divide the impedance characteristic Z_{B}, and an example thereof may be a method of dividing the impedance characteristic Z_{B} by the frequency range and setting impedance characteristics, respectively. For example, when the impedance characteristic Z_{B} is a synthetic impedance of an RL series circuit, the frequency characteristic is represented as the characteristic as illustrated in FIG. 6 as an example. In such a case, the impedance characteristic may be divided into the impedance characteristic Z_{BL} of the lower frequency range and the impedance characteristic Z_{BH} of the higher frequency range. Herein, when the impedance characteristic is divided by the frequency range, the resistance component is dominant in the lower frequency range (see FIG. 7), and the inductance component is dominant in the higher frequency range (see FIG. 8). Therefore, for example, the impedance characteristic Z_{BL} of the lower frequency range may be set for the virtual impedance element as a function of a resistor element, and the impedance characteristic Z_{BH} of the higher frequency range may be set for the explicit impedance element 74 as an inductance.

As described above, according to the present embodiment, the impedance characteristic Z_{B1}, which is a part of the impedance characteristic Z_{B} of the DUT 5, is set as a function for the virtual impedance element of the compensation voltage calculation element of the feedback voltage calculation model 70a, and the remaining characteristic Z_{B2} (=Z_{B}−Z_{B1}) is emulated with the explicit impedance element 74. Herein, the explicit impedance element 74 is connected in series to the voltage source element 61. This can reduce the change in the current of the simulation model 33a. As a result, even with a sudden change in the current of the simulation model 33a, the stability of the closed-loop system can be maintained. Further, such an advantageous effect can also be achieved for the stability of the system against a signal transmission delay or the like due to intervening of the interface 2.

Note that, although the case where the impedance characteristic Z_{B} of the DUT 5 is an impedance with a linear characteristic has been described as an example in the above embodiment, the impedance characteristic Z_{B} may partially have a nonlinear characteristic or a dynamic characteristic. Even in such a case, it is possible to easily and accurately identify the explicit impedance element 74 by dividing and separating the impedance characteristic Z_{B} into the component which is easy to emulate with a network of linear circuit elements and the remaining component.

### Third Embodiment

Next, a simulator, a simulation method, and a computer readable storage medium according to a third embodiment of the present disclosure will be described. Note that, in the followings, description of configurations common to those of the first embodiment will be omitted, and different features will be mainly described.

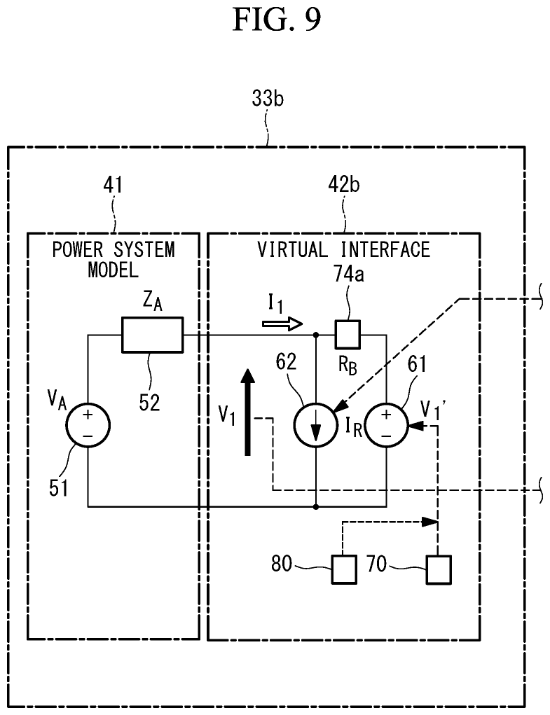

FIG. 9 is a diagram illustrating an example of a simulation model 33b of the simulator according to the present embodiment in a block diagram. As illustrated in FIG. 9, the simulation model 33b according to the present embodiment includes the explicit impedance element 74a connected in series to the voltage source element 61 and a voltage correction calculation model 80 configured to calculate a voltage correction signal used for compensating a voltage drop due to the explicit impedance element 74a being provided.

The explicit impedance element 74a may be of any impedance characteristic. However, it is preferable for the explicit impedance element 74a to be capable of maintaining the stability of the closed-loop system even with a sudden change in the current of the simulation model 33a and have a simple circuit configuration. For example, the explicit impedance element 74a may be implemented as a resistor element having a suitable resistance value.

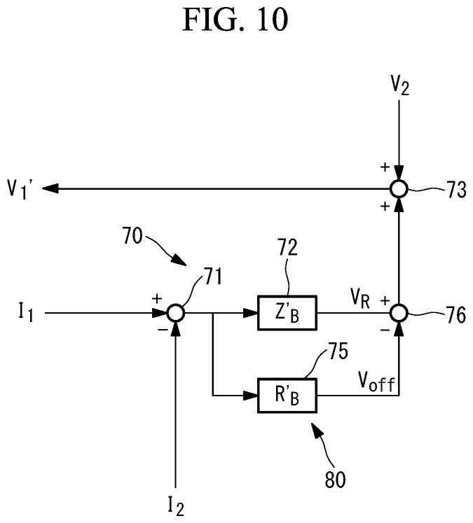

FIG. 10 is a diagram illustrating an example of the voltage correction calculation model 80 in a block diagram. As illustrated in FIG. 10, since the input signal to the voltage correction calculation model 80 is common to the input signal to the feedback voltage calculation model 70, the subtraction element 71 can be shared.

For example, the voltage correction calculation model (voltage correction calculation unit) 80 includes a virtual impedance element where the impedance characteristic of the explicit impedance element 74a is set as a function and calculates a voltage correction signal V_{off} by using the differential current signal ΔI, which is the difference between the current signal I₂ of the DUT 5 and the current signal I₁ of the power system model 41. This voltage correction signal V_{off} is reflected to the feedback voltage signal V₁ arithmetically calculated by the feedback voltage calculation model 70. Specifically, a feedback voltage signal V₁′ output to the voltage source element 61 is calculated based on the voltage compensation signal V_{R} arithmetically calculated by the feedback voltage calculation model 70 and also the voltage signal V₂ and the voltage correction signal V_{off} of the DUT 5. More specifically, the feedback voltage signal V₁′, which is resulted from subtraction of the voltage correction signal V_{off} from the feedback voltage signal V₁ arithmetically calculated by the feedback voltage calculation model 70, is output to the voltage source element 61.

As described above, according to the present embodiment, the explicit impedance element 74a is connected in series to the voltage source element 61. This can reduce the change in the current of the simulation model 33b. As a result, even with a sudden change in the current of the simulation model 33b, the stability of the closed-loop system can be maintained. Further, such an advantageous effect can also be achieved for the stability of the system against a signal transmission delay or the like due to intervening of the interface 2.

Furthermore, the simulation model 33b includes the voltage correction calculation model 80 that calculates such a voltage signal that cancels a voltage drop due to the explicit impedance element 74a being provided. This can eliminate the impact of a voltage drop due to the explicit impedance element 74a and can allow the power supply voltage to behave as if there were no explicit impedance element 74a.

### Fourth Embodiment

Next, a simulator according to a fourth embodiment will be described with reference to the drawings.

Although the first embodiment described above is configured such that the simulator 3 implements the simulation model 33 of a modelled power system that supplies a single-phase AC power, the simulator according to the present embodiment differs in implementing a plurality of simulation models 60a to 60c including a power system model of a modelled power system that supplies three-phase AC power.

In the followings for the simulator according to the present embodiment, description of configurations common to those of the first embodiment described above will be omitted, and different features will be mainly described.

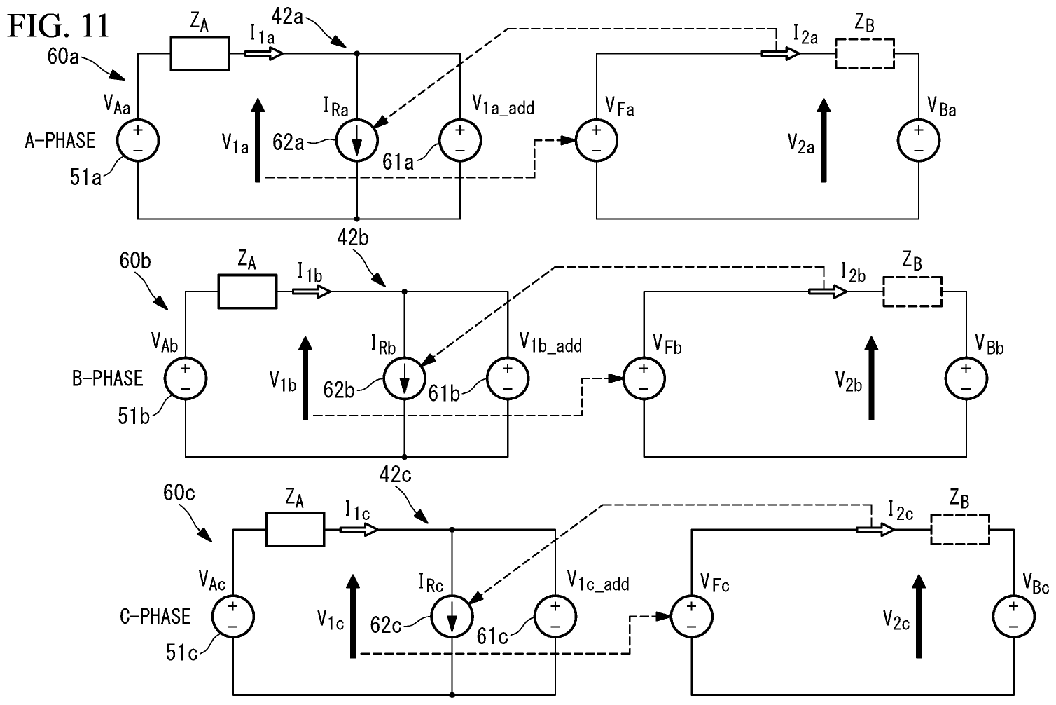

FIG. 11 is a diagram illustrating simulation models 60a to 60c as an example implemented by the simulator according to the present embodiment in a block diagram.

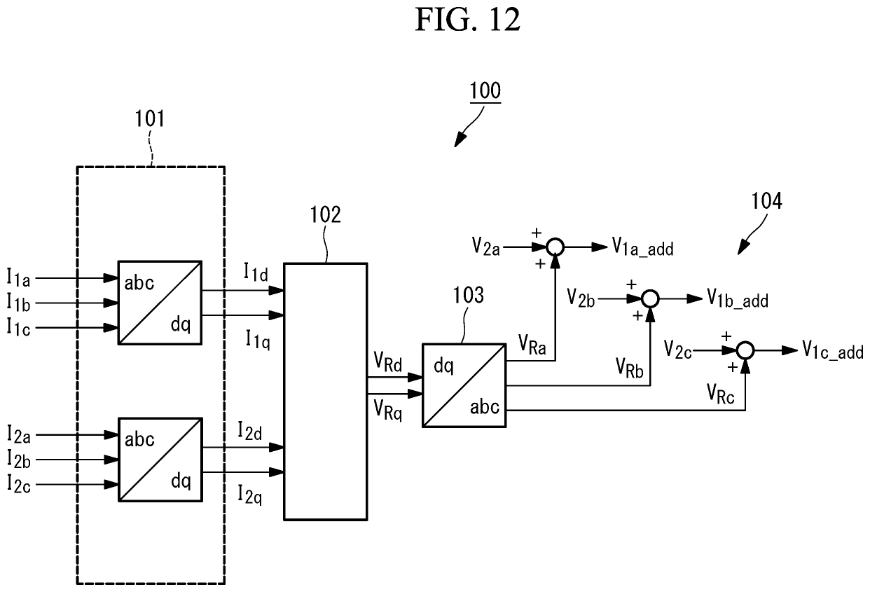

As illustrated in FIG. 11, the simulator according to the present embodiment has three simulation models 60a to 60c corresponding to respective phases of a three-phase AC voltage. In respective simulation models 60a to 60c, power supply elements 51a to 51c are provided that supply an a-phase voltage signal V_{Aa}, a b-phase voltage signal V_{Ab}, and a c-phase voltage signal V_{Ac} having phases shifted by 0 degree, 120 degrees, and −120 degrees, respectively. Further, the simulator implements a feedback voltage calculation model 100 (see FIG. 12) shared in the simulation models 60a to 60c.

Note that, although the DUT 5 is illustrated as including three models so as to correspond to respective phases in FIG. 11 for simplified illustration, the DUT 5 is hardware, and hardware components common to these models are used. That is, digital voltage signals for respective phases output from corresponding simulation models 60a to 60c are converted into analog signals in the interface, and three-phase AC voltages corresponding to these analog signals are output to the voltage source of the DUT 5 common to three phases.

In the simulation models 60a to 60c according to the present embodiment, dq-axis conversion capable of handling an instantaneous voltage and instantaneous current as DC values is used to measure the impedance characteristic of the DUT 5. In such a way, handling impedance characteristics as those on the dq-axis enables easier control or calculation.

FIG. 12 is a diagram illustrating the feedback voltage calculation model 100 as an example according to the present embodiment in a block diagram. As illustrated in FIG. 12, the feedback voltage calculation model 100 includes, for example, a three-phase/two-phase conversion element 101, a compensation voltage calculation element 102, a two-phase/three-phase conversion element 103, and an addition element 104.

The three-phase/two-phase conversion element 101 receives input of current signals I₁ₐ, I_{1b}, I_{1c} for respective phases of the power system model and converts these three-phase AC current signals into a d-axis current signal I_{1d} and a q-axis current signal I_{1q}. Similarly, the three-phase/two-phase conversion element 101 receives input of current signals I₂ₐ, I_{2b}, I_{2c} for respective phases of the DUT 5 and converts these three-phase AC current signals into a d-axis current signal I_{2d} and a q-axis current signal I_{2q}.

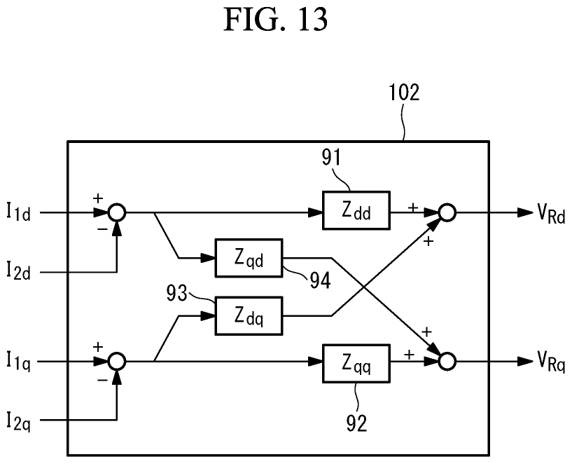

The compensation voltage calculation element 102 includes, for example, virtual impedance elements representing the impedance characteristics in the dq-coordinate system of the DUT 5 as a function. FIG. 13 is a diagram illustrating the model of the compensation voltage calculation element 102 as an example according to the present embodiment in a block diagram. As illustrated in FIG. 13, the compensation voltage calculation element 102 includes virtual impedance elements 91 to 94 where four dq-axis impedance components Z_{dd}, Z_{qq}, Z_{dq}, Z_{qd} are set as functions, respectively. A differential current signal, which is the difference between the d-axis current signal I_{1d} of the power system model and the d-axis current signal I_{2d} of the DUT 5, and a differential current signal, which is the difference between the q-axis current signal I_{1q} and the q-axis current signal I_{2q} of the DUT 5, are input to the virtual impedance elements 91 to 94, respectively, and thereby a d-axis voltage compensation signal V_{Rd} and a q-axis voltage compensation signal V_{Rq} are arithmetically calculated.

The two-phase/three-phase conversion element 103 performs two-phase to three-phase conversion on the d-axis voltage compensation signal V_{Rd} and the q-axis voltage compensation signal V_{Rq} to arithmetically calculate voltage compensation signals V_{Ra} to V_{Rc} of respective phases.

The addition element 104 adds the voltage compensation signals V_{Ra} to V_{Rc} of respective phases to voltage signals V₂ₐ to V_{2c} of respective phases of the DUT 5 to arithmetically calculate feedback voltage signals V_{1a_add} to V_{2c_add} of respective phases.

The feedback voltage signals V_{1a_add} to V_{2c_add} of respective phases are fed back to the voltage source elements 61a to 61c of the simulation models 60a to 60c of respective phases. Accordingly, voltages in accordance with feedback voltages of respective phases are generated by the voltage source elements 61a to 61c.

Next, a method of setting virtual impedance elements in the process of generating a simulation model implemented by the simulator according to the present embodiment will be described.

First, the impedance characteristic of the DUT 5 is acquired. Herein, dq-axis conversion is used to acquire the impedance characteristic of the DUT 5, specifically, acquire four dq-axis impedance components Z_{dd}, Z_{qq}, Z_{dq}, Z_{dq}. Note that, since various known schemes have been proposed for schemes to acquire dq-axis impedance characteristics of hardware, these schemes can be employed as appropriate.

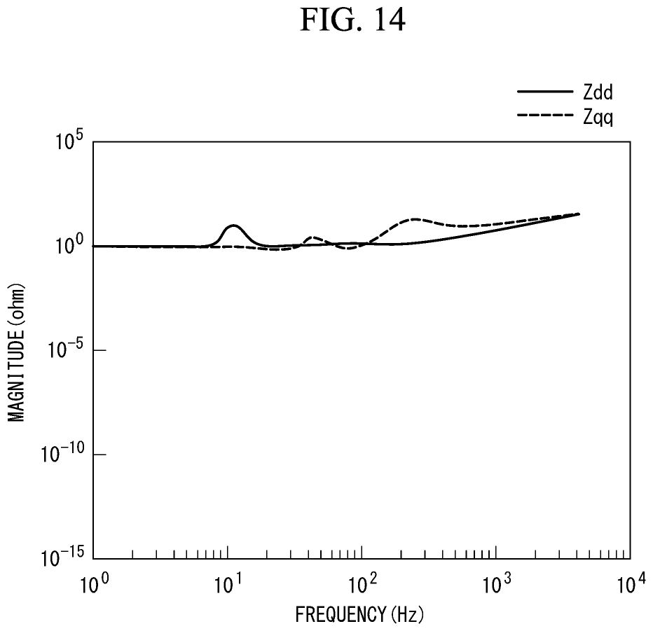

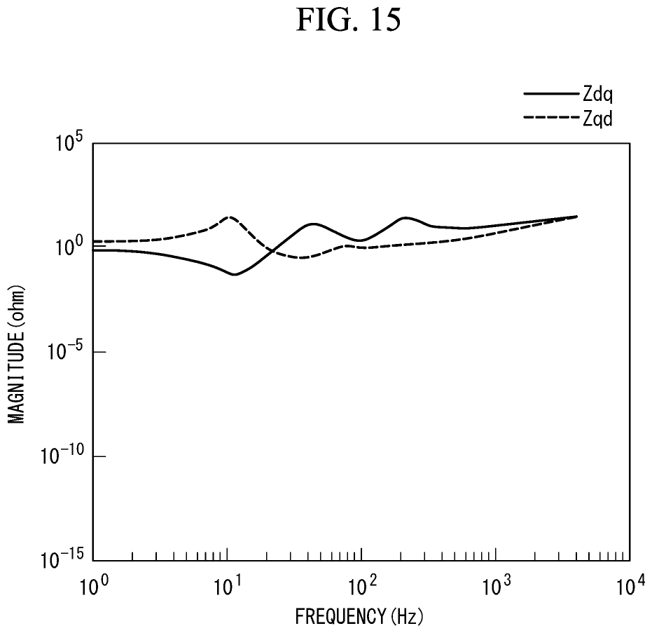

FIG. 14 illustrates an example of the dq-axis impedance components Z_{dd}, Z_{qq} for a network of linear circuit elements, and FIG. 15 illustrates an example of the dq-axis impedance components Z_{dq}, Z_{qd} for the resistance and reactance circuit.

Subsequently, respective dq-axis impedance components Z_{dd}, Z_{qq}, Z_{dq}, Z_{qd} are represented as functions and set for respective virtual impedance elements 91 to 94 of the compensation voltage calculation element 102 of the feedback voltage calculation model 100.

Once the virtual impedance elements 91 to 94 of the feedback voltage calculation model 100 are set in such a way, the DUT 5 is ready to be tested, and a simulation test on the DUT 5 may be started at any timing.

Next, the simulation method performed by the simulation system will be described.

Out of a series of processes described below, some or all of the processes performed by the simulator are stored in the secondary storage device 13 or the like in a form of a program as an example and implemented when the CPU (processor) 11 loads the program into the main storage device 12 and performs modification and calculation processes on information.

In a simulation test, various instances are emulated with the simulation models 60a to 60c of the simulator, and the voltage signals V₁ₐ to V_{1c} at this time are output to respective amplifiers (not illustrated) via respective DACs (note illustrated). Respective amplifiers supply voltages in accordance with the input voltage signals V₁ₐ to V_{1c} to a common voltage source of the DUT 5. Accordingly, three-phase AC power based on the voltage signals V₁ₐ to V_{1c} in the power system model is supplied to the DUT 5, and the DUT 5 is operated. The current and the voltage of the DUT 5 are measured by a current sensor and a voltage sensor (not illustrated), respectively, these current signals I₂ₐ to I_{2c} and the voltage signals V₂ₐ to V_{2c} are converted into digital signals by ADCs (not illustrated), and the converted digital signals are fed back to virtual interfaces 42a to 42c, respectively.

Specifically, the current signals I₂ₐ to I_{2c} of the DUT 5 are input to current source elements 62a to 62c of the virtual interfaces 42a to 42c, respectively, and input to the feedback voltage calculation model 100 (FIG. 12). Further, the voltage signals V₂ₐ to V_{2c} of the DUT 5 are input to the feedback voltage calculation model 100. Further, the current signals I₁ₐ to I_{1c} of the power system model are input to the feedback voltage calculation model 100.

In the feedback voltage calculation model 100 of the simulator, the d-axis voltage compensation signal V_{Rd} and the q-axis voltage compensation signal V_{Rq} are calculated by using the virtual impedance elements 91 to 94 where respective dq-axis impedance components Z_{dd}, Z_{qq}, Z_{dq}, Z_{qd} of the dq-axis impedance characteristics of the DUT 5 are set as functions, the d-axis current signal I_{2d} and the q-axis current signal I_{2q} that have been dq-axis-converted from the three-phase current signals I₂ₐ to I_{2c} of the DUT 5, and the d-axis current signal I_{1d} and the q-axis current signal I_{1q} that have been dq-axis-converted from the three-phase current signals I₁ₐ to I_{1c} of the power system model.

The voltage compensation signals V_{Ra} to V_{Rc}, which have been converted into three phases from the d-axis voltage compensation signal V_{Rd} and the q-axis voltage compensation signal V_{Rq}, are then arithmetically calculated, and the feedback voltage signals V_{la_add} to V_{1c_add} of respective phases are then arithmetically calculated by using the voltage compensation signals V_{Ra} to V_{Rc} of respective phases and the voltage signals V₂ₐ to V_{2c} of respective phases of the DUT 5. The feedback voltage signals V_{1a_add} to V_{1c_add} of respective phases are fed back to the voltage source elements 61a to 61c of the simulation models 60a to 60c of respective phases. Accordingly, voltages in accordance with respective feedback voltage signals V_{1a_add} to V_{1c_add} are generated by the voltage source elements 61a to 61c. These processes are then repeatedly performed, and thereby simulations are sequentially performed.

As described above, according to the present embodiment, the simulator implements a plurality of simulation models provided in association with respective phases of three-phase AC power. Further, the simulator calculates the dq-axis voltage compensation signals V_{Rd}, V_{Rq} by using the virtual impedance elements 91 to 94 where respective components of the dq-axis impedance characteristics of the device under test are set as functions, the d-axis current signal I_{2d} and the q-axis current signal 12q of the DUT 5, and the d-axis current signal I_{1d} and the q-axis current signal I_{1q} of the power system models. Furthermore, the simulator performs two-phase to three-phase conversion on the dq-axis voltage compensation signals V_{Rd}, V_{Rq} to calculate the voltage compensation signals V_{Ra} to V_{Rc} for respective phases. The voltage compensation signal V_{Ra} to V_{Rc} for respective phases and the voltage signals V₂ₐ to V_{2c} for respective phases of the DUT 5 are then used to calculate the feedback voltage signals V_{1a_add} to V_{1c_add} for respective phases.

For example, when the conventional explicit impedance element is used, it is not possible to directly emulate dq-impedance characteristics arithmetically calculated from a dq-voltage signal and a dq-current signal. Thus, steps of performing axis-conversion of the dq-impedance characteristic from the dq-axis (synchronization frame) into three-phase AC (stationary frame) and then identifying the impedance characteristic in a network of linear circuit elements are required.

In contrast, in the present embodiment, the virtual impedance elements 91 to 94 where dq-axis impedance characteristics are set as functions are used. This can eliminate the need for the steps of performing axis-conversion or the like on the dq-axis impedance characteristics or identifying the impedance characteristics by a circuit. As a result, the impedance characteristics of the DUT 5 in the three-phase AC system can be easily incorporated in a simulation model. Further, since the impedance characteristics are represented by functions, the emulation accuracy is expected to improve, and the simulation accuracy is thus expected to improve compared to a case where the conventional explicit impedance element is used.

Note that each of the second embodiment and the third embodiment described above can also be applied to the present embodiment.

For example, as with the second embodiment described above, explicit impedance elements may be connected in series to the voltage source elements 61a to 61c of respective simulation models 60a to 60c. In such a case, some of the impedance characteristics of the DUT 5 are allocated to the explicit impedance elements, and the remaining impedance characteristics are allocated to respective virtual impedance elements of the compensation voltage calculation element.

Further, as with the third embodiment described above, in respective simulation models 60a to 60c, explicit impedance elements having any impedance characteristics may be connected in series to the voltage source elements 61a to 61c of respective simulation models 60a to 60c, and voltage correction calculation models may be provided that calculate voltage correction signals used for cancelling voltage drop occurring due to the explicit impedance elements.

As described above, although the present disclosure has been described with reference to the embodiments, the technical scope of the present disclosure is not limited to the scope described in the above embodiments. Various modification or improvement can be added to the above embodiments within the scope not departing from the spirit of the disclosure, and forms to which such modification or improvement is added also fall in the technical scope of the present disclosure. Further, the above embodiments may be combined as appropriate.

Further, the flow of the processes described in the above embodiments is also an example, and an unnecessary step may be deleted, a new step may be added, or processing order may be exchanged within the scope not departing from the spirit of the present disclosure.

For example, although the case where an impedance characteristic is used as an electrical characteristic related to the resistance of the DUT 5 has been described as an example in each of the above embodiments, the impedance characteristic is not limited thereto. For example, an admittance characteristic may be used as the electrical characteristic related to the resistance.

Further, although the virtual impedance characteristic where a part or all of an impedance characteristic is set as a function is used in each of the embodiments described above, a scheme to virtually represent an electrical characteristic is not limited thereto, and a part or all of the impedance characteristic may be set as non-function such as table data (for example, a data array).

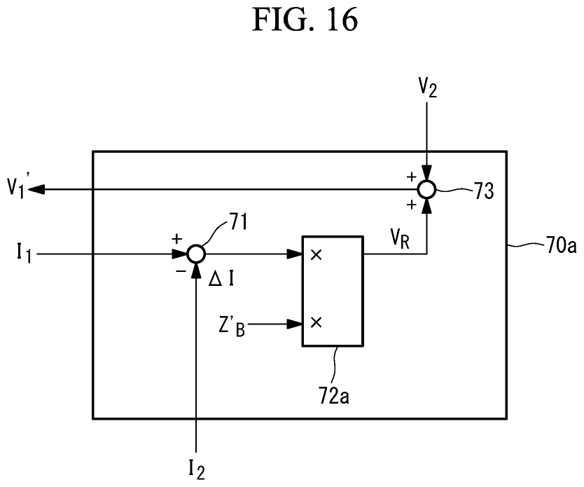

For example, as illustrated in FIG. 16, the electrical characteristic may be provided as a feedback value (input value), and an electrical characteristic Z′B and a differential current signal Δ1 output from the subtraction element 71 may be multiplied at the multiplication element 72a to calculate the voltage compensation signal V_{R}.

Further, although the case where the feedback voltage is output to the voltage source elements 61, 61a to 61c and the voltage value output from the voltage source elements 61, 61a to 61c is compensated has been described as an example in each of the above embodiments, the compensation is not limited thereto. For example, compensation may be performed on the current source elements 62, 62a to 62c instead of on the voltage source elements 61, 61a to 61c. In such a case, with the same consideration as in each of the above embodiments, the current compensation value and the feedback current signal may be calculated, and the feedback current signal may be output to the current source elements 62, 62a to 62c of the simulation model.

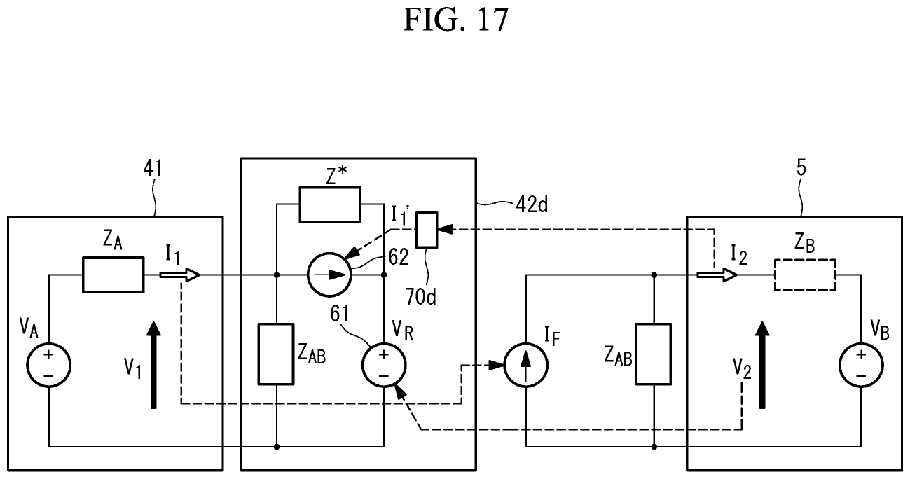

FIG. 17 illustrates an example of a block diagram of a virtual interface 42d when a current compensation signal I_{R} is fed back to the current source element 62. As illustrated in FIG. 17, the virtual interface 42d includes a feedback current calculation model (feedback current calculation unit) 70d. Herein, in FIG. 17, the impedance element Z_{AB} represents a linking impedance between the power system model 41 and the DUT 5. Note that, also in FIG. 3, FIG. 5, and FIG. 11 described above, the impedance element Z_{AB} may be provided in the same manner as in FIG. 17.

The feedback current calculation model 70d calculates the current compensation signal I_{R} as a compensation signal by using a virtual impedance (virtual electrical characteristic element), a voltage signal of the DUT 5, and a voltage signal of the power system model 41, calculate a feedback current signal I₁ as the feedback electrical signal by using the current compensation signal I_{R} and the current signal I₂ of the DUT 5, and outputs the feedback current signal I₁ to the current source element 62 of the simulation model.

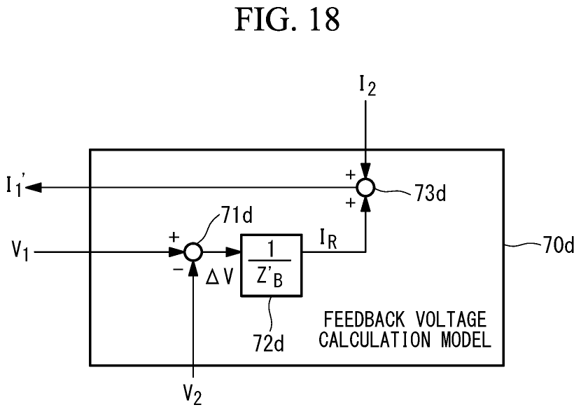

FIG. 18 is a diagram illustrating an example of the feedback current calculation model 70d in a block diagram. As illustrated in FIG. 18, the feedback current calculation model 70d includes a subtraction element (subtraction unit) 71d, a compensation current calculation element (compensation current calculation unit) 72d, and an addition element (addition unit) 73d.

For example, the subtraction element 71d acquires the voltage signal V₁ of the power system model 41 and the voltage signal V₂ of the DUT 5 and outputs a differential voltage signal ΔV (=V₁−V₂), which is a difference between these voltage signals. The compensation current calculation element 72d includes a virtual impedance element where the reciprocal of the impedance characteristic (for example, the electrical characteristic related to the resistance) Z_{B} of the DUT 5 is set as a function (in other words, virtual admittance element Y_{B}′=1/Z_{B}′). The compensation current calculation element 72d uses the virtual impedance element and the differential voltage signal ΔV to calculate (arithmetically calculate) the current compensation signal I_{R}. Specifically, the compensation current calculation element 72d calculates the current compensation signal I_{R} by multiplying the virtual admittance element (Y_{B}′=1/Z_{B}′) by the differential voltage signal ΔV.

The addition element 73d calculates the feedback current signal I₁ by adding the current compensation signal I_{R} to the current signal I₂ of the DUT 5. The feedback current signal I₁, which is the output of the addition element 73d, is input to the current source element 62. Accordingly, virtual current in accordance with the feedback current signal I₁′ is generated by the current source element 62.

As discussed above, a virtual impedance is introduced to the feedback current signal I₁′, and the same advantageous effects as those in the first embodiment described above is expected to be obtained, accordingly.

Further, the above aspect can be similarly applied to the second embodiment and the third embodiment.

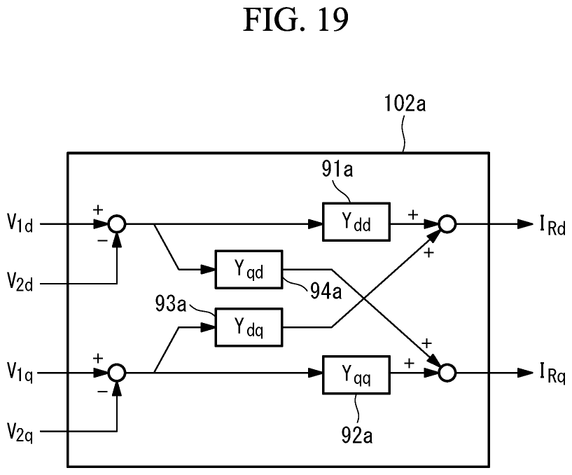

For example, in the simulation models corresponding to respective phases of three-phase AC power according to the third embodiment described above, when current compensation is performed on the current source elements 62a to 62c, a compensation current calculation element 102a illustrated in FIG. 19 can be used as an example. For example, as illustrated in FIG. 19, the virtual admittance elements 91a to 94a where dq-axis admittance characteristics of the DUT 5 are set as functions, the d-axis voltage signal Vid and the q-axis voltage signal V₁q of the DUT 5, and the d-axis voltage signal V₂ₐ and the q-axis voltage signal V_{2q} of the power system model are used to calculate dq-axis current compensation signals I_{Rd}, I_{Rq}, two-phase to three-phase conversion is performed on the dq-axis current compensation signals I_{Rd}, I_{Rq} to calculate the current compensation signals I_{Ra} to I_{Rc} for respective phases, and the current compensation signals I_{Ra} to I_{Rc} for respective phases and the current signals I₂ₐ to I_{2c} for respective phases of the DUT 5 are used to calculate feedback current signals I_{1a_add} to I_{1c_add} for respective phases.

Accordingly, the same advantageous effects are expected as in a case where voltage compensation is performed on the voltage source elements 61a to 61c.

The simulator, the simulation method, and the computer readable storage medium according to each embodiment described above are understood as follows, for example.

A simulator (3) according to the first aspect of the present disclosure is a simulator (3) including at least one simulation model (33, 33a, 33b) including a power system model (41) of a modelled electric power system to which a device under test (5) is connected, the simulator being configured to connect to a device under test (5) as hardware via an interface (2) and perform a simulation on the simulation model to test an operation of the device under test, and the simulator including: one or more memories (13) storing the simulation model and a program; and one or more processors (11) configured to execute the program to: calculate a compensation signal by using a virtual electrical characteristic element, an electrical signal of the device under test, and an electrical signal of the power system model, the compensation signal being for compensating output of a power supply element of the simulation model, and the virtual electrical characteristic element virtually representing a part or all of an electrical characteristic related to the resistance of the device under test; calculate a feedback electrical signal by using the compensation signal and the electrical signal of the device under test; and output the feedback electrical signal to the power supply element (61, 61a to 61c, 62, 62a to 62c) of the simulation model.

According to the above aspect, the use of the virtual electrical characteristic element virtually representing electrical characteristics of a device under test enables modeling of the electrical characteristics of the device under test that would be difficult to be emulated with a network of linear circuit elements as with the conventional art. Accordingly, simulation errors due to intervening of an interface can be effectively reduced, and the simulation accuracy is expected to improve. Further, the stability of the power system model and a real machine are expected to improve.

Further, the use of the virtual electrical characteristic element can eliminate the need for identifying circuit elements (resistors, inductors, capacitors, or the like) that would be required in using the explicit impedance, and this can make it easier to build a simulation model.

In the simulator according to the second aspect of the present disclosure, in the first aspect described above, the power supply element is a voltage source element (61, 61a to 61c), and the one or more processors are configured to: calculate a voltage compensation signal as the compensation signal by using the virtual electrical characteristic element, a current signal of the device under test, and a current signal of the power system model; calculate a feedback voltage signal as the feedback electrical signal by using the voltage compensation signal and a voltage signal of the device under test; and output the feedback voltage signal to the power supply element of the simulation model.

According to the above aspect, the voltage compensation signal that compensates a simulation error due to intervening of an interface can be reflected to the voltage source element of the simulation model.

In the simulator according to the third aspect of the present disclosure, in the first aspect described above, the power supply element is a current source element (62, 62a to 62c), and the one or more processors are configured to: calculate a current compensation signal as the compensation signal by using the virtual electrical characteristic element, a voltage signal of the device under test, and a voltage signal of the power system model; calculate a feedback current signal as the feedback electrical signal by using the current compensation signal and a current signal of the device under test; and output the feedback current signal to the power supply element of the simulation model.

According to the above aspect, the current compensation signal that compensates a simulation error due to intervening of an interface can be reflected to the current source element of the simulation model.

In the simulator according to the fourth aspect of the present disclosure, in any one of the first aspect to the third aspect described above, in the simulation model, an explicit electrical characteristic element (74, 74a) including at least any one of a resistor element (R), an inductor element (L), and a capacitor element (C) is connected in series or parallel to the power supply element (61, 61a to 61c, 62, 62a to 62c).

According to the above aspect, a change in the current of the simulation model can be reduced. As a result, even with a sudden change in the current of the simulation model, the stability of a closed-loop system is expected to be maintained. Further, such an advantageous effect is also expected for the stability of the system against a signal transmission delay or the like due to intervening of the interface.

In the simulator according to the fifth aspect of the present disclosure, in the fourth aspect described above, a part of the electrical characteristic of the device under test is set for the virtual electrical characteristic element, and the explicit electrical characteristic element is an element emulating the remaining of the electrical characteristic of the device under test.

According to the above aspect, a change in the current of the simulation model can be reduced. As a result, even with a sudden change in the current of the simulation model, the stability of a closed-loop system is expected to be maintained. Further, such an advantageous effect is also expected for the stability of the system against a signal transmission delay or the like due to intervening of the interface.

In the simulator according to the sixth aspect of the present disclosure, in the fourth aspect described above, all of the electrical characteristic of the device under test is set for the virtual electrical characteristic element, and the one or more processors are configured to: calculate a correction signal by using a virtual circuit element, the electrical signal of the device under test, and electrical signal of the power system model, the virtual circuit element virtually representing the electrical characteristic of the explicit electrical characteristic element; and calculate the feedback electrical signal by using the compensation signal, the correction signal, and the electrical signal of the device under test.

According to the above aspect, a change in the current of the simulation model can be reduced. As a result, even with a sudden change in the current of the simulation model, the stability of a closed-loop system is expected to be maintained. Further, such an advantageous effect is also expected for the stability of the system against a signal transmission delay or the like due to intervening of the interface.

In the simulator according to the seventh aspect of the present disclosure, in any one of the first aspect to the sixth aspect described above, the electrical characteristic is an impedance characteristic or an admittance characteristic.

The simulator according to the eighth aspect of the present disclosure, in the first aspect described above, has a plurality of simulation models, each of the simulation models is provided in association with a corresponding phase of three-phase AC power, and the one or more processors are configured to: calculate a dq-axis compensation signal by using the virtual electrical characteristic element, a dq-axis electrical signal of the device under test, and a dq-axis electrical signal of the power system model, the virtual electrical characteristic element virtually representing dq-axis electrical characteristics of the device under test; calculate a compensation signal for each phase by performing two-phase to three phase conversion on the dq-axis compensation signal; and calculate the feedback electrical signal for each phase by using the compensation signal for each phase and the electrical signal for each phase of the device under test.

According to the above aspect, also in the power system that supplies three-phase AC power, the simulation accuracy can be improved. Further, the stability of the power system model is expected to improve.

Further, the use of the virtual electrical characteristic element can eliminate the need for identifying circuit elements (resistors, inductors, capacitors, or the like) and axis conversion that would be required in using the explicit impedance, and the impedance characteristic of a device under test in three-phase AC system can be easily incorporated in a simulation model.

In the simulator according to the ninth aspect of the present disclosure, in the eighth aspect described above, in each of the simulation models, an explicit electrical characteristic element including at least any one of a resistor element (R), an inductor element (L), and a capacitor element (C) is connected in series to the power supply element (61a to 61c).

According to the above aspect, a change in the current of the simulation model can be reduced. As a result, even with a sudden change in the current of the simulation model, the stability of a closed-loop system is expected to be maintained. Further, such an advantageous effect is also expected for the stability of the system against a signal transmission delay or the like due to intervening of the interface.

In the simulator according to the tenth aspect of the present disclosure, in the ninth aspect described above, a part of the electrical characteristic of the device under test is set for the virtual electrical characteristic element, and the explicit electrical characteristic element is an element emulating the remaining of the electrical characteristic of the device under test.

According to the above aspect, a change in the current of the simulation model can be reduced. As a result, even with a sudden change in the current of the simulation model, the stability of a closed-loop system is expected to be maintained. Further, such an advantageous effect is also expected for the stability of the system against a signal transmission delay or the like due to intervening of the interface.

In the simulator according to the eleventh aspect of the present disclosure, in the ninth aspect described above, the one or more processors are configured to: calculate a correction signal for each phase by using a virtual circuit element, the electrical signal of the device under test, and an electrical signal for each phase of the power system model, the virtual circuit element virtually representing an electrical characteristic of the explicit electrical characteristic element; and calculate the feedback electrical signal for each phase by using the compensation signal for each phase, the correction signal for each phase, and an electrical signal for each phase of the device under test.

According to the above aspect, a change in the current of the simulation model can be reduced. As a result, even with a sudden change in the current of the simulation model, the stability of a closed-loop system is expected to be maintained. Further, such an advantageous effect is also expected for the stability of the system against a signal transmission delay or the like due to intervening of the interface.

A simulation method according to the twelfth aspect of the present disclosure is a simulation method for testing an operation of a device under test as hardware by connecting a simulator to the device under test via an interface and performing a simulation on at least one simulation model, the simulator including the simulation model, and the simulation model including a power system model of a modelled electric power system to which the device under test is connected. The simulation method includes: at the simulator, calculating a compensation signal by using a virtual electrical characteristic element, an electrical signal of the device under test, and an electrical signal of the power system model, the compensation signal being for compensating output of a power supply element of the simulation model, and the virtual electrical characteristic element virtually representing a part or all of an electrical characteristic related to the resistance of the device under test; calculating a feedback electrical signal by using the compensation signal and the electrical signal of the device under test; and outputting the feedback electrical signal to the power supply element of the simulation model.

In the simulation method according to the thirteenth aspect of the present disclosure, in the twelfth aspect described above, in the simulation model, an explicit electrical characteristic element including at least any one of a resistor element, an inductor element, and a capacitor element is connected in series or parallel to the power supply element.

In the simulation method according to the fourteenth aspect of the present disclosure, in the thirteenth aspect described above, a part of the electrical characteristic of the device under test is set for the virtual electrical characteristic element, and the explicit electrical characteristic element is an element emulating the remaining of the electrical characteristic of the device under test.

In the simulation method according to the fifteenth aspect of the present disclosure, in the thirteenth aspect described above, all of the electrical characteristic of the device under test is set for the virtual electrical characteristic element. The simulation method includes: at the simulator, calculating a correction signal by using a virtual circuit element, the electrical signal of the device under test, and electrical signal of the power system model, the virtual circuit element virtually representing the electrical characteristic of the explicit electrical characteristic element; and calculating the feedback electrical signal by using the compensation signal, the correction signal, and the electrical signal of the device under test.

In the simulation method according to the sixteenth aspect of the present disclosure, in any one of the twelfth aspect to the fifteenth aspect described above, the electrical characteristic is an impedance characteristic or an admittance characteristic.

In the simulation method according to the seventeenth aspect of the present disclosure, in the twelfth aspect described above, the simulator includes a plurality of simulation models, and each of the simulation models is provided in association with respective phases of three-phase AC power. The simulation method includes: at the simulator, calculating a dq-axis compensation signal by using the virtual electrical characteristic element, a dq-axis electrical signal of the device under test, and a dq-axis electrical signal of the power system model, the virtual electrical characteristic element virtually representing dq-axis electrical characteristics of the device under test; calculating a compensation signal for each phase by performing two-phase to three phase conversion on the dq-axis compensation signal; and calculating the feedback electrical signal for each phase by using the compensation signal for each phase and the electrical signal for each phase of the device under test.

In the simulation method according to the eighteenth aspect of the present disclosure, in the seventeenth aspect described above, in each of the simulation models, an explicit electrical characteristic element including at least any one of a resistor element, an inductor element, and a capacitor element is connected in series or parallel to the power supply element.

In the simulation method according to the nineteenth aspect of the present disclosure, in the eighteenth aspect described above, a part of the electrical characteristic of the device under test is set for the virtual electrical characteristic element, and the explicit electrical characteristic element is an element emulating the remaining of the electrical characteristic of the device under test.

The simulation method according to the twentieth aspect of the present disclosure, in the eighteenth aspect described above, includes: at the simulator, calculating a correction signal for each phase by using a virtual circuit element, the electrical signal of the device under test, and an electrical signal for each phase of the power system model, the virtual circuit element virtually representing an electrical characteristic of the explicit electrical characteristic element; and calculating the feedback electrical signal for each phase by using the compensation signal for each phase, the correction signal for each phase, and an electrical signal for each phase of the device under test.

A non-transitory computer readable storage medium according to the 21th aspect of the present disclosure stores a program for causing a computer to function as the simulator according to any one of the first aspect to the eleventh aspect described above.

### LIST OF REFERENCES SYMBOLS

1: simulation system
2: interface
3: simulator
5: device under test (DUT)
7: subtraction element
11: CPU (processor)
12: main storage device
13: secondary storage device (memory)
14: communication interface
15: external interface
16: input device
17: output device
21: voltage source
25: current sensor
26: voltage sensor
31: controller
32: storage unit
33: simulation model
33a: simulation model
33b: simulation model
41: power system model
42: virtual interface
42a: virtual interface
42b: virtual interface
42c: virtual interface
42d: virtual interface
51: power supply element
51a: power supply element
51b: power supply element
51c: power supply element
52: impedance element
60a: simulation model
60b: simulation model
60c: simulation model
61: voltage source element
61a: voltage source element
61b: voltage source element
61c: voltage source element
62: current source element
62a: current source element
62b: current source element
62c: current source element
70: feedback voltage calculation model
70a: feedback voltage calculation model
70d: feedback current calculation model
71: subtraction element
71d: subtraction element
72: compensation voltage calculation element
72a: multiplication element
72d: compensation current calculation element
73: addition element
73d: addition element
74: explicit impedance element
74a: explicit impedance element
80: voltage correction calculation model
91: virtual impedance element
91a: virtual admittance element
92: virtual impedance element
92a: virtual admittance element
93: virtual impedance element
93a: virtual admittance element
94: virtual impedance element
94a: virtual admittance element
100: feedback voltage calculation model
101: three-phase/two-phase conversion element
102: compensation voltage calculation element
102a: compensation current calculation element
103: two-phase/three-phase conversion element
104: addition element

What is claimed is:

1. A simulator comprising at least one simulation model including a power system model of a modelled electric power system to which a device under test is connected, the simulator being configured to connect to a device under test as hardware via an interface and perform a simulation on the simulation model to test an operation of the device under test,
the simulator comprising:
one or more memories storing the simulation model and a program; and
one or more processors configured to execute the program to:
calculate a compensation signal by using a virtual electrical characteristic element, an electrical signal of the device under test, and an electrical signal of the power system model, the compensation signal being for compensating output of a power supply element of the simulation model, and the virtual electrical characteristic element virtually representing a part or all of an electrical characteristic related to the resistance of the device under test;
calculate a feedback electrical signal by using the compensation signal and the electrical signal of the device under test; and
output the feedback electrical signal to the power supply element of the simulation model.

2. The simulator according to claim 1,
wherein the power supply element is a voltage source element, and
wherein the one or more processors are configured to:
calculate a voltage compensation signal as the compensation signal by using the virtual electrical characteristic element, a current signal of the device under test, and a current signal of the power system model;
calculate a feedback voltage signal as the feedback electrical signal by using the voltage compensation signal and a voltage signal of the device under test; and
output the feedback voltage signal to the power supply element of the simulation model.

3. The simulator according to claim 1
wherein the power supply element is a current source element, and
wherein the one or more processors are configured to:
calculate a current compensation signal as the compensation signal by using the virtual electrical characteristic element, a voltage signal of the device under test, and a voltage signal of the power system model;
calculate a feedback current signal as the feedback electrical signal by using the current compensation signal and a current signal of the device under test; and
output the feedback current signal to the power supply element of the simulation model.

4. The simulator according to claim 1, wherein in the simulation model, an explicit electrical characteristic element including at least any one of a resistor element, an inductor element, and a capacitor element is connected in series or parallel to the power supply element.

5. The simulator according to claim 4,
wherein a part of the electrical characteristic of the device under test is set for the virtual electrical characteristic element, and
wherein the explicit electrical characteristic element is an element emulating the remaining of the electrical characteristic of the device under test.

6. The simulator according to claim 4,
wherein all of the electrical characteristic of the device under test is set for the virtual electrical characteristic element, and
wherein the one or more processors are configured to:
calculate a correction signal by using a virtual circuit element, the electrical signal of the device under test, and electrical signal of the power system model, the virtual circuit element virtually representing the electrical characteristic of the explicit electrical characteristic element; and
calculate the feedback electrical signal by using the compensation signal, the correction signal, and the electrical signal of the device under test.

7. The simulator according to claim 1, wherein the electrical characteristic is an impedance characteristic or an admittance characteristic.

8. The simulator according to claim 1 comprising a plurality of simulation models,
wherein each of the simulation models is provided in association with a corresponding phase of three-phase AC power, and
wherein the one or more processors are configured to:
calculate a dq-axis compensation signal by using the virtual electrical characteristic element, a dq-axis electrical signal of the device under test, and a dq-axis electrical signal of the power system model, the virtual electrical characteristic element virtually representing dq-axis electrical characteristics of the device under test;
calculate a compensation signal for each phase by performing two-phase to three phase conversion on the dq-axis compensation signal; and
calculate the feedback electrical signal for each phase by using the compensation signal for each phase and the electrical signal for each phase of the device under test.

9. The simulator according to claim 8, wherein in each of the simulation models, an explicit electrical characteristic element including at least any one of a resistor element, an inductor element, and a capacitor element is connected in series or parallel to the power supply element.

10. The simulator according to claim 9,
wherein a part of the electrical characteristic of the device under test is set for the virtual electrical characteristic element, and
wherein the explicit electrical characteristic element is an element emulating the remaining of the electrical characteristic of the device under test.

11. The simulator according to claim 9, wherein the one or more processors are configured to:
calculate a correction signal for each phase by using a virtual circuit element, the electrical signal of the device under test, and an electrical signal for each phase of the power system model, the virtual circuit element virtually representing an electrical characteristic of the explicit electrical characteristic element; and
calculate the feedback electrical signal for each phase by using the compensation signal for each phase, the correction signal for each phase, and an electrical signal for each phase of the device under test.

12. A simulation method for testing an operation of a device under test as hardware by connecting a simulator to the device under test via an interface and performing a simulation on at least one simulation model, the simulator comprising the simulation model, and the simulation model including a power system model of a modelled electric power system to which the device under test is connected, the simulation method comprising:
at the simulator,
calculating a compensation signal by using a virtual electrical characteristic element, an electrical signal of the device under test, and an electrical signal of the power system model, the compensation signal being for compensating output of a power supply element of the simulation model, and the virtual electrical characteristic element virtually representing a part or all of an electrical characteristic related to the resistance of the device under test;
calculating a feedback electrical signal by using the compensation signal and the electrical signal of the device under test; and
outputting the feedback electrical signal to the power supply element of the simulation model.

13. The simulation method according to claim 12, wherein in the simulation model, an explicit electrical characteristic element including at least any one of a resistor element, an inductor element, and a capacitor element is connected in series or parallel to the power supply element.

14. The simulation method according to claim 13,
wherein a part of the electrical characteristic of the device under test is set for the virtual electrical characteristic element, and
wherein the explicit electrical characteristic element is an element emulating the remaining of the electrical characteristic of the device under test.

15. The simulation method according to claim 13, wherein all of the electrical characteristic of the device under test is set for the virtual electrical characteristic element,
the simulation method comprising:
at the simulator,
calculating a correction signal by using a virtual circuit element, the electrical signal of the device under test, and electrical signal of the power system model, the virtual circuit element virtually representing the electrical characteristic of the explicit electrical characteristic element; and
calculating the feedback electrical signal by using the compensation signal, the correction signal, and the electrical signal of the device under test.

16. The simulation method according to claim 12, wherein the electrical characteristic is an impedance characteristic or an admittance characteristic.

17. The simulation method according to claim 12,
wherein the simulator comprises a plurality of simulation models, and
wherein each of the simulation models is provided in association with a corresponding phase of three-phase AC power,
the simulation method comprising:
at the simulator,
calculating a dq-axis compensation signal by using the virtual electrical characteristic element, a dq-axis electrical signal of the device under test, and a dq-axis electrical signal of the power system model, the virtual electrical characteristic element virtually representing dq-axis electrical characteristics of the device under test;
calculating a compensation signal for each phase by performing two-phase to three phase conversion on the dq-axis compensation signal; and
calculating the feedback electrical signal for each phase by using the compensation signal for each phase and the electrical signal for each phase of the device under test.

18. The simulation method according to claim 17, wherein in each of the simulation models, an explicit electrical characteristic element including at least any one of a resistor element, an inductor element, and a capacitor element is connected in series or parallel to the power supply element.

19. The simulation method according to claim 18,
wherein a part of the electrical characteristic of the device under test is set for the virtual electrical characteristic element, and
wherein the explicit electrical characteristic element is an element emulating the remaining of the electrical characteristic of the device under test.

20. The simulation method according to claim 18 further comprising:
at the simulator,
calculating a correction signal for each phase by using a virtual circuit element, the electrical signal of the device under test, and an electrical signal for each phase of the power system model, the virtual circuit element virtually representing an electrical characteristic of the explicit electrical characteristic element; and
calculating the feedback electrical signal for each phase by using the compensation signal for each phase, the correction signal for each phase, and an electrical signal for each phase of the device under test.

21. A non-transitory computer readable storage medium storing a program for causing a computer to function as the simulator according to claim 1.
